(19) United States
(12) Patent Application Publication
(10) Pub. No.: US 2025/0093693 A1
(43) Pub. Date: Mar. 20, 2025

(54) DISPLAY DEVICE AND MANUFACTURING METHOD FOR DISPLAY DEVICE

(71) Applicant: Shanghai Tianma Micro-Electronics Co., Ltd., Shanghai (CN)

(72) Inventors: Koetsu ISHIKAWA, Kawasaki (JP); Hitoshi YOSHIDA, Kawasaki (JP); Akira BANJOUYA, Kawasaki (JP); Akira SUZUKI, Kawasaki (JP); Shingo ASAKA, Kawasaki (JP); Noriyuki ITOU, Kawasaki (JP); Futoshi NAKANISHI, Kawasaki (JP)

(73) Assignee: Shanghai Tianma Micro-Electronics Co., Ltd., Shanghai (CN)

(21) Appl. No.: 18/828,549

(22) Filed: Sep. 9, 2024

(30) Foreign Application Priority Data
Sep. 19, 2023 (JP) 2023-151183
Jun. 3, 2024 (JP) 2024-090215

(51) Int. Cl. G02F 1/1333

(52) U.S. Cl. CPC G02F 1/133331; G02F 1/133325; G02F 1/133602

(57) ABSTRACT

A display device includes at least one display unit, a cover disposed on a display surface side of the at least one display unit, a housing that accommodates the at least one display unit, and a first anti-scattering part disposed on the cover and extending between the display nit and the inner surface of the housing. The first anti-scattering part is inclined at an acute angle with respect to the rear direction of the display unit.

### CROSS-REFERENCE TO RELATED APPLICATIONS

This application claims the benefits of Japanese Patent Application No. 2023-151183, filed on Sep. 19, 2023, and Japanese Patent Application No. 2024-090215, filed on Jun. 3, 2024, the entire disclosures of which are incorporated by reference herein.

### FIELD OF THE INVENTION

The present disclosure relates generally to a display device and a manufacturing method for the display device.

### BACKGROUND OF THE INVENTION

In order to enhance the safety of riders (crew, passengers, and the like) on vehicles, trains, and the like, it is necessary to reduce injury caused to the riders by display devices provided in the vehicles, trains, and the like. For example, the European standards for vehicles (ECE-R21: the Economic Commission for Europe of the United Nations (UN/ECE)-Regulation No. 21) apply to interior components of vehicles, including display devices. ECE-R21 requires a high level of safety for the interior components of vehicles for passenger protection.

As an onboard display device, a display device with a high-strength cover glass is known. A housing that can prevent the cover glass from scattering is also known. For example, Unexamined Japanese Patent Application Publication No. 2017-026694 discloses a display device housing including a housing body having side walls opposing each other, and display device holders that are fixed to each of the side walls and hold the display device having a display surface to which a cover glass is attached. In Unexamined Japanese Patent Application Publication No. 2017-026694, the display device holders fall off from the housing body before the cover glass breaks when an impact force that could cause the cover glass to break is applied to the cover glass.

In Unexamined Japanese Patent Application Publication No. 2017-026694, falling off of the display device holders from the housing body suppresses breaking and scattering of the cover glass. However, such falling off of the display device and the display device holders from the housing body might cause fragments of components of the display device to scatter into the vehicle from the gap between the display device holder or the display device and the housing body.

### SUMMARY OF THE INVENTION

A display device according to a first aspect of the present disclosure includes:
at least one display unit;
a cover disposed on a display surface side of the at least one display unit,
a housing that accommodates the at least one display unit; and
a first anti-scattering part disposed on the cover and extending between the display unit and an inner surface of the housing, wherein
the first anti-scattering part is inclined at an acute angle with respect to the rear direction of the display unit.

A manufacturing method for a display device according to a second aspect of the present disclosure includes:
a first step of attaching an anti-scattering part to a main surface of a cover;
a second step of providing a display unit on the main surface of the cover with the anti-scattering part attached thereto, wherein
the anti-scattering part extends in a rear direction of the display unit and is inclined toward the display unit side with respect to the rear direction of the display unit, and
in the second step, the display unit is provided on the main surface of the cover, with the anti-scattering part pressed toward a side opposite an area where the display unit is provided.

A manufacturing method for a display device according to a third aspect of the present disclosure includes:
a first step of providing a display unit on a main surface of a cover; and
a second step of attaching, to the cover on which the display unit is provided, an anti-scattering part extending in a rear direction of the display unit and inclined toward a display unit side with respect to the rear direction of the display unit.

It is to be understood that both the foregoing general description and the following detailed description are exemplary and explanatory and are not restrictive of this disclosure.

### BRIEF DESCRIPTION OF DRAWINGS

FIG. 1 is a cross-sectional view illustrating a display device according to Embodiment 1;

FIG. 2 is a cross-sectional view illustrating a liquid crystal display panel according to Embodiment 1;

FIG. 3 is a plan view illustrating a cover, a display unit, and a first anti-scattering part according to Embodiment 1;

FIG. 4 is a cross-sectional view of the cover, the display unit, and the first anti-scattering part illustrated in FIG. 3, taken along line A-A, according to Embodiment 1;

FIG. 5 is a schematic diagram illustrating a damaged state of the display device according to Embodiment 1;

FIG. 6 is a cross-sectional view illustrating a display device according to Embodiment 2;

FIG. 7 is a schematic diagram illustrating a damaged state of the display device according to Embodiment 2;

FIG. 8 is a flowchart illustrating a manufacturing method for a crystal display device according to Embodiment 2;

FIG. 9 is a schematic diagram for explaining the manufacturing method for the display device according to Embodiment 2;

FIG. 10 is a cross-sectional view illustrating a display device according to Embodiment 3;

FIG. 11 is a schematic diagram illustrating a cross-section of the display device according to Embodiment 3;

FIG. 12 is a cross-sectional view illustrating a display device according to Embodiment 4;

FIG. 13 is a schematic diagram illustrating a cross-section of the display device according to Embodiment 4;

FIG. 14 is a cross-sectional view illustrating a display device according to Embodiment 5;

FIG. 15 is a plan view illustrating a cover, a display unit, and a first anti-scattering part according to Embodiment 5;

FIG. 16 is a schematic diagram illustrating a damaged state of the display device according to Embodiment 5;

FIG. 17 is a cross-sectional view illustrating a display device according to Embodiment 6;

FIG. 18 is a plan view illustrating a cover, a display unit, a first anti-scattering part, a second anti-scattering part according to Embodiment 6;

FIG. 19 is a cross-sectional view illustrating a display device according to Embodiment 7;

FIG. 20 is a schematic diagram illustrating a first anti-scattering part and a side surface of the display unit according to Embodiment 7;

FIG. 21 is a cross-sectional view illustrating a display device according to Embodiment 8;

FIG. 22 is a schematic diagram illustrating a first anti-scattering part and an inner surface of a housing according to Embodiment 8;

FIG. 23 is a perspective view illustrating an end portion of a first anti-scattering part according to a modified example;

FIG. 24 is a perspective view illustrating the end portion of the first anti-scattering part according to a modified example;

FIG. 25 is a schematic diagram illustrating a first anti-scattering part according to a modified example;

FIG. 26 is a schematic diagram illustrating a first anti-scattering part according to a modified example;

FIG. 27 is a schematic diagram illustrating a first anti-scattering part according to a modified example;

FIG. 28 is a schematic diagram illustrating a first anti-scattering part according to a modified example;

FIG. 29 is a schematic diagram illustrating a first anti-scattering part according to a modified example;

FIG. 30 is a schematic diagram illustrating a first anti-scattering part according to a modified example;

FIG. 31 is a flowchart illustrating a manufacturing method for a display device according to a modified example;

FIG. 32 is a schematic diagram illustrating a cover according to a modified example;

FIG. 33 is a cross-sectional view illustrating a display device according to a modified example; and

FIG. 34 is a schematic diagram illustrating an anti-scattering part having a first anti-scattering part and a second anti-scattering part integrated together, according to a modified example.

### DETAILED DESCRIPTION OF THE INVENTION

A display device according to various embodiments is described below with reference to the drawings.

### Embodiment 1

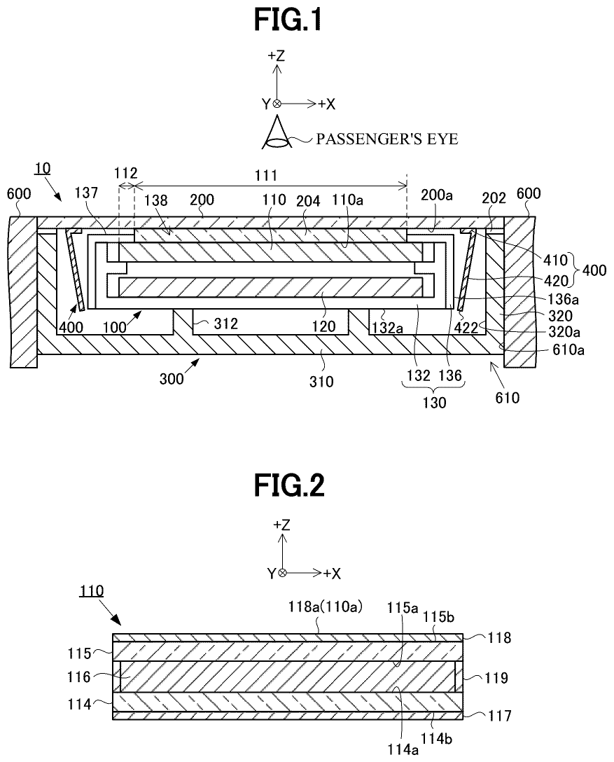

A display device 10 according to the present embodiment is described with reference to FIGS. 1 to 5. The display device 10 is mounted in a vehicle, an airplane, on a household appliance, a piece of furniture, or the like. In the present embodiment and the following embodiments, examples in which the display device 10 is mounted in a vehicle are described. A passenger of the vehicle corresponds to a user (observer).

As illustrated in FIG. 1, the display device 10 is disposed in an opening 610 of an instrument panel 600 of the vehicle. In one example, the instrument panel 600 is formed of resin. For ease of understanding, the longitudinal direction of the display device 10 in FIG. 1 (the right direction on the paper) is described herein as a +X direction, the transverse direction (the back direction on the paper) as a +Y direction, and the direction perpendicular to the +X and +Y directions (the up direction on the paper, passenger direction) as a +Z direction. The +Z direction and the direction parallel to the +Z direction are defined as a front direction of a display unit 100 described later, and a −Z direction and the direction parallel to the −Z direction are defined as a rear direction of the display unit 100. For ease of understanding, hatching of a chassis 132, a bezel 136, and the like is omitted in FIG. 1. In the subsequent figures, hatching may also be omitted.

The display device 10 includes a display unit 100, a cover 200, a housing 300, and a first anti-scattering part 400. The display unit 100 displays characters, images, and the like. The cover 200 protects the display unit 100. The housing 300 accommodates the display unit 100. The first anti-scattering part 400 suppresses scattering of pieces of glass, resin, metal, etc. due to damage of the display unit 100.

As illustrated in FIG. 1, the display unit 100 of the display device 10 includes a liquid crystal display panel 110, a back light 120, and a unit housing 130.

In one example, the liquid crystal display panel 110 of the display unit 100 is implemented as a known transmissive horizontal electric field type liquid crystal display panel.

The liquid crystal display panel 110 is active matrix driven by thin film transistors (TFT). The liquid crystal display panel 110 displays characters, images, and the like by modulating light from the back light 120. The liquid crystal display panel 110 includes a display region 111 and a periphery 112. The display region 111 is a region in which pixels are arranged in a matrix, and characters, images, and the like can be displayed. The periphery 112 is a region in which wirings, drive circuits, and the like are disposed.

As illustrated in FIG. 2, the liquid crystal display panel 110 includes a TFT substrate 114, a counter substrate 115, a liquid crystal 116, a first polarizing plate 117, and a second polarizing plate 118. The TFT substrate 114 and the counter substrate 115 sandwich the liquid crystal 116. The first polarizing plate 117 is provided on the TFT substrate 114. The second polarizing plate 118 is provided on the counter substrate 115.

In one example, the TFT substrate 114 is implemented as a glass substrate. The TFT substrate 114 is positioned on the −Z side. TFTs for selecting the pixels, common electrodes, pixel electrodes, a drive circuit, an alignment film for aligning the liquid crystal 116, and the like (all not illustrated in the drawings) are provided on a main surface 114a on the liquid crystal 116 side of the TFT substrate 114. The first polarizing plate 117 is provided on a main surface 114b on the side opposite a main surface 114a of the TFT substrate 114.

The counter substrate 115 is positioned on the +Z side, and opposes the TFT substrate 114. The counter substrate 115 is adhered to the TFT substrate 114 by a seal material 119. In one example, the counter substrate 115 is implemented as a glass substrate. A color filter, a black matrix, an alignment film for aligning the liquid crystal 116, and the like (all not illustrated in the drawings) are provided on a main surface 115a on the liquid crystal 116 side of the counter substrate 115. The second polarizing plate 118 is provided on a main surface 115b on the side opposite the main surface 115a of the counter substrate 115.

In one example, the TFT substrate 114 and the counter substrate 115 are formed of alkali-free glass. Alkali-free glass does not contain alkali components such as sodium and potassium, which can suppress contamination of the liquid crystal 116 by alkali components and degradation of the display quality of the liquid crystal display panel 110.

The liquid crystal 116 is sandwiched by the TFT substrate 114 and the counter substrate 115. In one example, the liquid crystal 116 is implemented as a positive nematic liquid crystal. The liquid crystal 116 is initially aligned, by the alignment film, in a direction parallel to the main surface 114a of the TFT substrate 114. Additionally, the liquid crystal 116 rotates in a plane parallel to the main surface 114a of the TFT substrate 114 when voltage is applied.

The first polarizing plate 117 is provided on the main surface 114b of the TFT substrate 114. The second polarizing plate 118 is provided on the main surface 115b of the counter substrate 115. One transmittance axis of the transmittance axes of the first polarizing plate 117 and the second polarizing plate 118 is arranged parallel to the initial alignment direction of the liquid crystal 116, and the transmission axis of the first polarizing plate 117 is orthogonal to the transmittance axis of the second polarizing plate 118. In the present embodiment, a main surface 118a on the +Z side of the second polarizing plate 118 corresponds to a display surface 110a of the liquid crystal display panel 110 (that is, a display surface 110a of the display unit 100).

As illustrated in FIG. 1, the back light 120 of the display unit 100 is disposed on a rear side (the −Z side) of the liquid crystal display panel 110. The back light 120 is a light source of the liquid crystal display panel 110. The back light 120 emits white light on the liquid crystal display panel 110. The back light 120 includes a white light emitting diode (LED) element, a reflecting sheet, a diffusing sheet, a light guide plate, a lighting circuit, and the like (all not illustrated in the drawings). In one example, the light guide plate is formed of a light-transmitting acrylic resin (poly methyl methacrylate (PMMA)).

The unit housing 130 of the display unit 100 accommodates the liquid crystal display panel 110 and the back light 120. The unit housing 130 includes a chassis 132 and a bezel 136. However, a configuration is possible in which the bezel 136 is not provided on the unit housing 130.

The chassis 132 has a box-like shape. The chassis 132 is formed of resin or metal. The chassis 132 accommodates, on an inner side thereof, the liquid crystal display panel 110 and the back light 120.

The bezel 136 has a box-like shape. The bezel 136 has an opening 138 on a bottom 137 thereof. In one example, the bezel 136 is formed of metal. The bezel 136 covers the chassis 132 with the bottom 137 facing the +Z side, and protects the periphery 112 of the liquid crystal display panel 110. The display region 111 of the liquid crystal display panel 110 is exposed through the opening 138.

The cover 200 of the display device 10 is disposed on the display surface 110a side (+Z side) of the display unit 100 and protects the display unit 100. The cover 200 is shaped into a flat plate and formed of a light-transmitting resin, glass, etc. In a case of the cover 200 formed of glass, the cover 200 is typically formed of tempered glass, but the cover 200 may also be formed of soda-lime glass. The outer shape (X direction, Y direction) of the cover 200 is larger than the outer shape (X direction, Y direction) of the display unit 100. Thus, as illustrated in FIG. 1, in a cross-sectional view, the cover 200 extends outward from the outer shape of the display unit 100. In the present embodiment, the cover 200 is attached to a side plate 320 of the later-described housing 300 by an adhesive member 202. Space between the cover 200 and the liquid crystal display panel 110 is filled with a light-transmitting adhesive 204 (for example, optical clear adhesive (OCA)).

The housing 300 of the display device 10 has a box-like shape and houses the display unit 100. In one example, the housing 300 is formed of metal. The housing 300 includes a bottom plate 310 and a side plate 320. In the present embodiment, the housing 300 supports the display unit 100 by a support 312 of the bottom plate 310. The side plate 320 is adhered, by a non-illustrated adhesive, to an inner wall surface 610a of the opening 610 of the instrument panel 600. The display device 10 is thereby fixed to the opening 610 of the instrument panel 600.

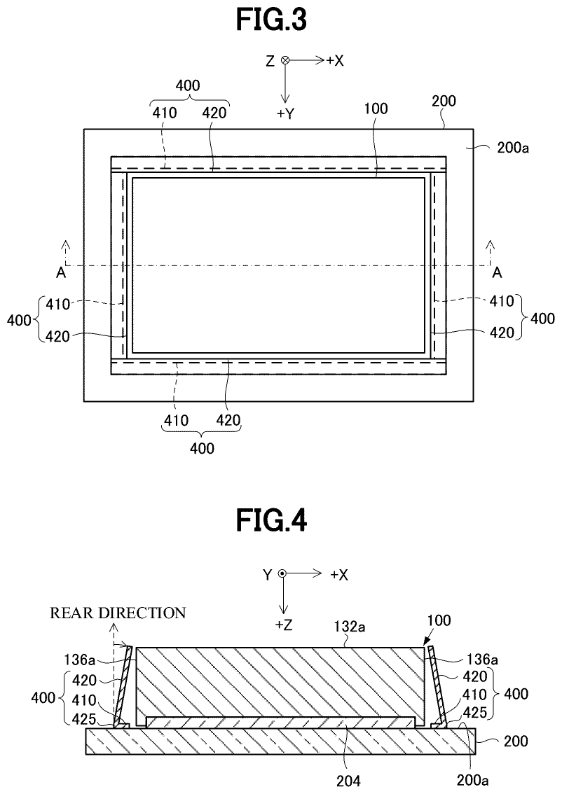

As illustrated in FIGS. 1, 3, and 4, the four first anti-scattering parts 400 of the display device 10 are provided on the main surface 200a of the cover 200 on the display unit 100 side thereof. When viewed in plan, the four first anti-scattering parts 400 extend along the long side (X direction) or short side (Y direction) of the display unit 100 and surround the display unit 100 in a frame-like manner, as illustrated in FIG. 3. In FIGS. 3 and 4, the display unit 100 is simplified and illustrated for ease of understanding. In the subsequent figures, the display unit 100 may be simplified.

The first anti-scattering part 400 includes a first fixing portion 410 and a first shielding portion 420. The first fixing portion 410 is attached to the main surface 200a of the cover 200 via a non-illustrated adhesive member. In the present embodiment, as illustrated in FIGS. 1 and 4, the first fixing portion 410 is attached to the main surface 200a of the cover 200 at a portion located outward from the side surface 136a of the display unit 100. The first fixing portion 410 is disposed between the side surface 136a of the display unit 100 and the inner surface 320a of the side plate 320 of the housing 300.

As illustrated in FIG. 1, the first shielding portion 420 extends from the first fixing portion 410 between the side surface 136a (side surface 136a of the bezel 136) of the display unit 100 and the inner surface 320a of the side plate 320 of the housing 300. As illustrated in FIG. 4, the first shielding portion 420 is inclined at an acute angle toward the side surface 136a side of the display unit 100 with respect to the rear direction (a line extending in parallel to the −Z direction and passing through a junction 425 between the first fixing portion 410 and the first shielding portion 420) of the display unit 100. That is, an angle between the first shielding portion 420 and the rear direction of the display unit 100 is an acute angle open to the rear direction of the display unit 100 (−Z direction). The first anti-scattering part 400 can be considered as having an L-shape with the first shielding portion 420 inclined at an acute angle with respect to the rear direction of the display unit 100 when viewed in cross-section.

In one example, the first anti-scattering part 400 is formed of a synthetic resin, metal, rubber, etc. In the present embodiment, the first anti-scattering part 400 is formed of a synthetic resin. As illustrated in FIG. 4, the first anti-scattering part 400 is disposed with the junction 425 (L-shaped bend) facing the outer periphery of the cover 200.

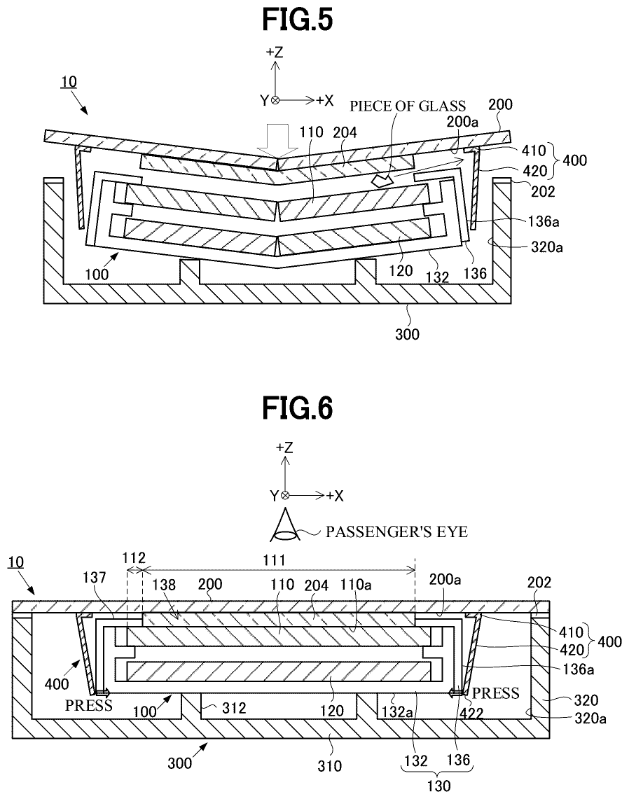

In the present embodiment, when the display device 10 is damaged due to an impact applied on the display device 10 (cover 200) from the passenger side (+Z side), the first shielding portion 420 of the first anti-scattering part 400 closes the gap between the cover 200 and the display unit 100 (bezel 136) as illustrated in FIG. 5, since the first shielding portion 420 extends between the side surface 136a of the display unit 100 and the inner surface 320a of the side plate 320 of the housing 300. This can suppress scattering of pieces of glass, resin, metal, etc. into the vehicle through between the cover 200 and the display unit 100.

Also, the first shielding portion 420 of the first anti-scattering part 400 is inclined at an acute angle toward the side surface 136a side of the display unit 100 with respect to the rear direction of the display unit 100, and thus, the gap between the side surface 136a of the display unit 100 and the first shielding portion 420 can be narrowed. In addition, even if a portion of the cover 200 to which the first anti-scattering part 400 (first fixing portion 410) is attached deforms, expansion of the gap between the side surface 136a of the display unit 100 and the first shielding portion 420 due to the first shielding portion 420 displaced toward the inner surface 320a of the housing 300 can be suppressed since the first shielding portion 420 is previously placed to be inclined at an acute angle toward the side surface 136a side of the display unit 100 with respect to the rear direction of the display unit 100. This can suppress scattering of pieces of glass, resin, metal, etc. from between the first shielding portion 420 and the display unit 100. That is, the first anti-scattering part 400 is particularly effective in suppressing scattering of pieces of glass of the TFT substrate 114 and the counter substrate 115, pieces of resin and metal of a light guide plate, the chassis 132, the bezel 136, etc. caused from the display unit 100 due to damage of the display device 10.

As above, the first shielding portion 420 of the first anti-scattering part 400 extends between the side surface 136a of the display unit 100 and the inner surface 320a of the side plate 320 of the housing 300 and is inclined at an acute angle toward the side surface 136a side of the display unit 100 with respect to the rear direction of the display unit 100, and thus, scattering of pieces of glass, resin, metal, etc. due to damage into the vehicle can be suppressed. This can enhance the safety of the display device 10 for users.

### Embodiment 2

In Embodiment 1, the first anti-scattering part 400 is formed of a synthetic resin. The first anti-scattering part 400 may be metal, rubber, etc. having elasticity (spring property). With the exception of the configuration of the first anti-scattering part 400, the configuration of the display device 10 of the present embodiment is the same as the configuration of the display device 10 of Embodiment 1. Here, the first anti-scattering part 400 of the present embodiment is described.

The first anti-scattering part 400 of the present embodiment is formed of a metal thin plate having elasticity (spring property). The first anti-scattering part 400 of the present embodiment has an elastic restoring force in a direction where the first fixing portion 410 and the first shielding portion 420 close. In the present embodiment, the first shielding portion 420 of the first anti-scattering part 400 is in contact with the display unit 100 (side surface 136a) as illustrated in FIG. 6, and presses the display unit 100 in the center direction of the display unit 100. The other configurations of the first anti-scattering part 400 of the present embodiment are the same as the first anti-scattering part 400 of Embodiment 1. In FIG. 6, the first shielding portion 420 is illustrated as flat, but the first shielding portion 420 may be curved due to elasticity.

In the present embodiment, the first shielding portion 420 of the first anti-scattering part 400 is pressed against the display unit 100, and thus, even if the display device 10 is damaged, the first shielding portion 420 can maintain contact with the display unit 100, as illustrated in FIG. 7. Thus, gaps between the display unit 100 and the first shielding portion 420 are less likely to occur, and scattering of pieces of glass, metal, etc. due to damage into the vehicle can be suppressed.

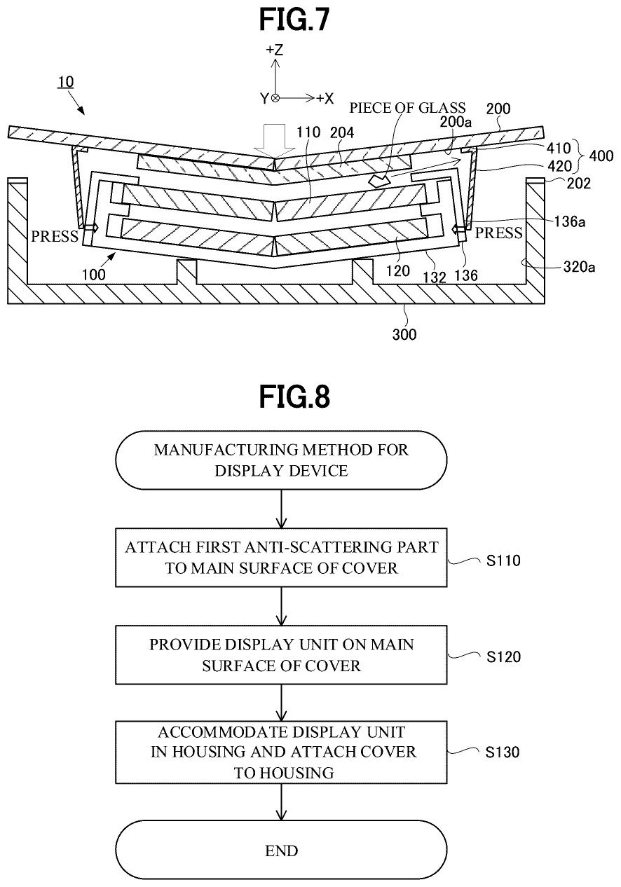

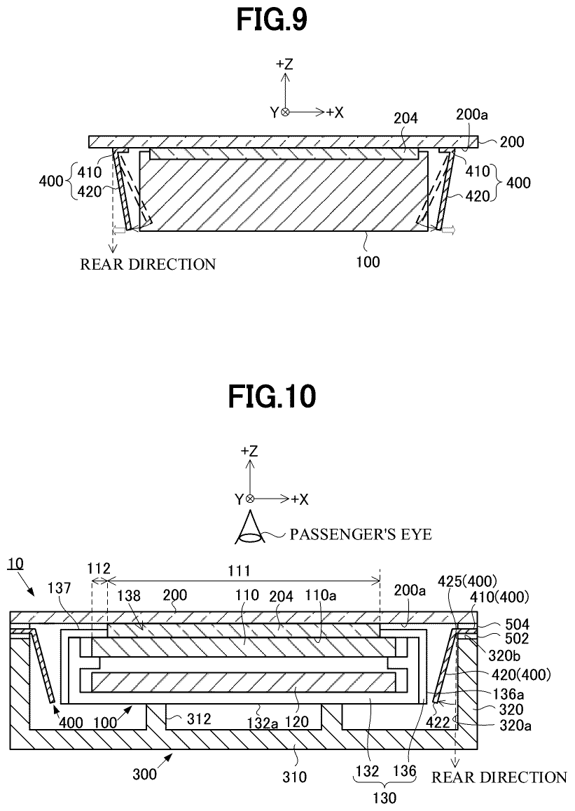

Next, a manufacturing method for the display device 10 of the present embodiment is described with reference to FIGS. 8 and 9. FIG. 8 is a flowchart illustrating the manufacturing method for the display device 10. The manufacturing method for the display device 10 includes a step of attaching the first anti-scattering part 400 to the main surface 200a of the cover 200 (step S110), a step of providing a display unit 100 on the main surface 200a of the cover 200 to which the first anti-scattering part 400 is attached (step S120), and a step of accommodating the display unit 100 in the housing 300 and attaching the cover 200 to the housing 300 (step S130).

In step S110, the first anti-scattering part 400 formed of metal having elasticity is attached to the main surface 200a of the cover 200. Specifically, the first fixing portion 410 of the first anti-scattering part 400 is adhered to the main surface 200a of the cover 200 with an adhesive member (e.g., a double-sided tape).

In step S120, as illustrated in FIG. 9, the first shielding portion 420 of the first anti-scattering part 400 is pressed using a non-illustrated jig toward a side opposite an area where the display unit 100 is disposed to secure a space for the display unit 100, and the display unit 100 with the adhesive 204 applied on the display surface 110a is disposed on the main surface 200a of the cover 200, with the first shielding portion 420 pressed. Then, the adhesive 204 is cured to adhere the display unit 100 to the cover 200. After curing of the adhesive 204, the pressing of the first shielding portion 420 is released, and the first shielding portion 420 is brought into contact with the display unit 100. This can achieve a state where the first shielding portion 420 of the first anti-scattering part 400 is pressed on the display unit 100.

In step S130, the display unit 100 attached to the cover 200 is accommodated in the housing 300 and the cover 200 is attached to the side plate 320 of the housing 300 by the adhesive member 202. The display device 10 can be manufactured by the above process.

As above, the first shielding portion 420 of the first anti-scattering part 400 presses the display unit 100, and thus, even if the display device 10 is damaged, the first shielding portion 420 can maintain contact with the display unit 100, and scattering of pieces of glass, resin, metal, etc. into the vehicle due to damage can be further suppressed. This can enhance the safety of the display device 10 for users.

### Embodiment 3

The first fixing portion 410 of the first anti-scattering part 400 may be positioned between the cover 200 and the side plate 320 of the housing 300. With the exception of the configuration and arrangement of the first anti-scattering part 400, the configuration of the display device 10 of the present embodiment is the same as the configuration of the display device 10 of Embodiment 1. Here, the first anti-scattering part 400 of the present embodiment is described.

The first anti-scattering part 400 of the present embodiment includes the first fixing portion 410 and the first shielding portion 420, similarly to the first anti-scattering part 400 of Embodiment 1. The first anti-scattering part 400 of the present embodiment is formed of a synthetic resin, similarly to the first anti-scattering part 400 of Embodiment 1.

In the present embodiment, the first fixing portion 410 of the first anti-scattering part 400 is positioned between the cover 200 and the side plate 320 of the housing 300, as illustrated in FIG. 10. Specifically, the first fixing portion 410 is positioned between the cover 200 and the top surface 320b of the side plate 320 of the housing 300. The first fixing portion 410 is adhered to the top surface 320b of the side plate 320 of the housing 300 by a first adhesive member 502 and is adhered to the main surface 200a of the cover 200 by a second adhesive member 504.

In one example, the first adhesive member 502 and the second adhesive member 504 are double-sided tapes. In the present embodiment, adhesion to adhere the first fixing portion 410 to the main surface 200a of the cover 200 by the second adhesive member 504 is greater than adhesion to adhere the first fixing portion 410 to the top surface 320b of the side plate 320 of the housing 300 by the first adhesive member 502. In other words, adhesion to adhere the first fixing portion 410 to the main surface 200a of the cover 200 by the second adhesive member 504 is stronger than adhesion to adhere the first fixing portion 410 to the top surface 320b of the side plate 320 of the housing 300 by the first adhesive member 502. When the display device 10 is damaged, this can maintain a state where the first anti-scattering part 400 is attached to the main surface 200a of the cover 200.

The first shielding portion 420 of the first anti-scattering part 400 extends between the side surface 136a of the display unit 100 and the inner surface 320a of the side plate 320 of the housing 300, similarly to the first shielding portion 420 of Embodiment 1. Also, the first shielding portion 420 is inclined at an acute angle toward the side surface 136a side of the display unit 100 with respect to the rear direction of the display unit 100.

The other configurations of the first anti-scattering part 400 of the present embodiment are the same as the first anti-scattering part 400 of Embodiment 1.

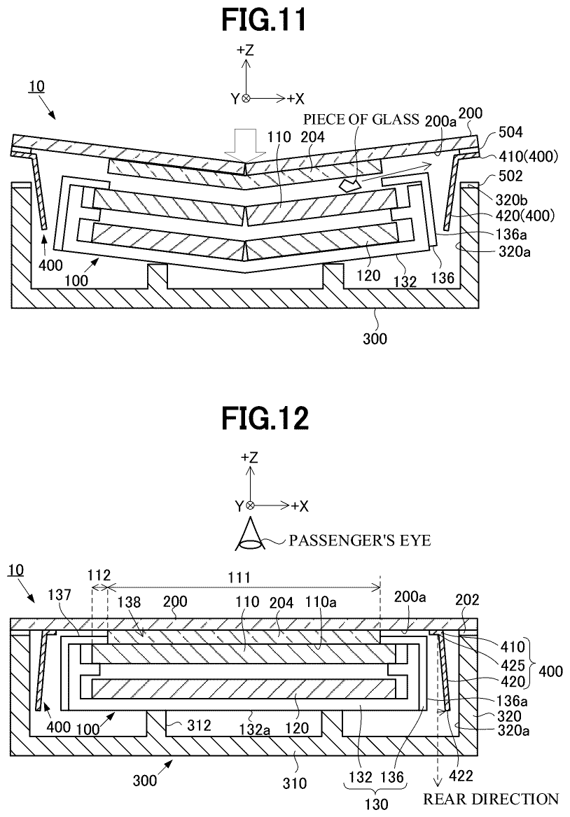

As illustrated in FIG. 11, when the display device 10 is damaged due to an impact from the passenger side (+Z side), the first anti-scattering part 400 remains on the main surface 200a of the cover 200 and the first shielding portion 420 closes the gap between the cover 200 and the housing 300 (side plate 320) since adhesion to adhere the first fixing portion 410 to the main surface 200a of the cover 200 is greater than adhesion to adhere the first fixing portion 410 to the top surface 320b of the side plate 320 of the housing 300. This can suppress scattering of pieces of glass, resin, metal, etc. into the vehicle through between the cover 200 and the housing 300.

In the present embodiment, the first shielding portion 420 closes the gap between the cover 200 and the housing 300 (side plate 320), and thus, even if pieces of glass, resin, metal, etc. caused inside of the display device 10 due to damage of the display device 10 occurs on the rear side of the display unit 100, scattering of these pieces into the vehicle can be suppressed.

As above, the display device 10 of the present embodiment can suppress scattering of pieces of glass, resin, metal, etc. due to damage into the vehicle and enhance the safety for users. In addition, since the first fixing portion 410 of the first anti-scattering part 400 is positioned above the side plate 320 of the housing 300, less space is needed to provide the first anti-scattering part 400 and the spacing between the display unit 100 and the side plate 320 of the housing 300 can be narrowed.

### Embodiment 4

In Embodiments 1 to 3, the first shielding portion 420 of the first anti-scattering part 400 is inclined at an acute angle toward the side surface 136a side of the display unit 100 with respect to the rear direction of the display unit 100. The first shielding portion 420 may be inclined at an acute angle on toward the inner surface 320a of the housing 300 with respect to the rear direction of the display unit 100. With the exception of the configuration of the first anti-scattering part 400, the configuration of the display device 10 of the present embodiment is the same as the configuration of the display device 10 of Embodiment 1. The first anti-scattering part 400 of the present embodiment is described.

The first anti-scattering part 400 of the present embodiment includes the first fixing portion 410 and the first shielding portion 420, similarly to the first anti-scattering part 400 of Embodiment 1. The first anti-scattering part 400 of the present embodiment is formed of a synthetic resin and disposed on the main surface 200a of the cover 200, similarly to the first anti-scattering part 400 of Embodiment 1.

The first fixing portion 410 is attached to the main surface 200a of the cover 200 via an adhesive member. As illustrated in FIG. 12, the first shielding portion 420 extends from the first fixing portion 410 to between the side surface 136a of the display unit 100 and the inner surface 320a of the side plate 320 of the housing 300, and is inclined at an acute angle toward the inner surface 320a side of the housing 300 with respect to the rear direction of the display unit 100.

The other configurations of the first anti-scattering part 400 of the present embodiment are the same as the first anti-scattering part 400 of Embodiment 1.

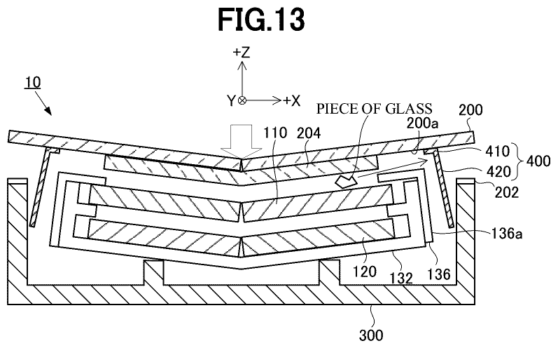

As illustrated in FIG. 13, when the display device 10 is damaged due to an impact from the passenger side (+Z side), the first shielding portion 420 inclined at an acute angle toward the inner surface 320a side of the housing 300 with respect to the rear direction of the display unit 100 closes the gap between the cover 200 and the housing 300 (side plate 320). This can suppress scattering of pieces of glass, metal, etc. into the vehicle through between the cover 200 and the housing 300.

As above, the display device 10 of the present embodiment can suppress scattering of pieces of glass, metal, etc. due to damage into the vehicle and enhance the safety for users.

### Embodiment 5

In Embodiment 1, the housing 300 accommodates the display unit 100. The housing 300 may accommodate a component other than the display unit 100. In the plurality of first anti-scattering parts 400, the first shielding portions 420 may have end portions 422 whose heights (positions) from the cover 200 are different.

The display device 10 of the present embodiment includes the display unit 100, the cover 200, the housing 300, three first anti-scattering parts 400A, a single first anti-scattering part 400B, and an imager 700. The configurations of the display unit 100 and the cover 200 of the present embodiment are the same as in Embodiment 1 and, as such, here, the imager 700, the housing 300, the first anti-scattering parts 400A, and the first anti-scattering part 400B are described.

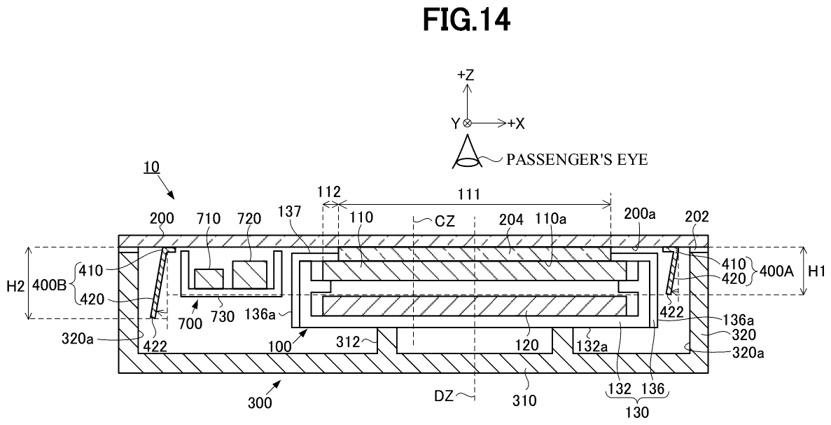

The imager 700 captures images of passengers, a vehicle interior, etc. The imager 700 is accommodated in the housing 300, as illustrated in FIG. 14. The imager 700 has a light source 710 and an imaging element 720. The light source 710 and the imaging element 720 are disposed in an imager housing 730.

The light source 710 is a white LED element, an infrared LED element, etc. The imaging element 720 is a charged coupled device (CCD) image sensor, an infrared image sensor, or the like.

The housing 300 of the present embodiment accommodates the display unit 100 and the imager 700. The display unit 100 and the imager 700 are arranged side by side in the X direction in the housing 300. Specifically, the display unit 100 is positioned on the +X side and the imager 700 is positioned on the −X side. Thus, when viewed in cross-section on the XZ plane, as illustrated in FIG. 14, the center line DZ bisecting the display unit 100 is shifted in the +X direction with respect to the center line CZ bisecting the cover 200. The other configurations of the housing 300 of the present embodiment are the same as the housing 300 of Embodiment 1.

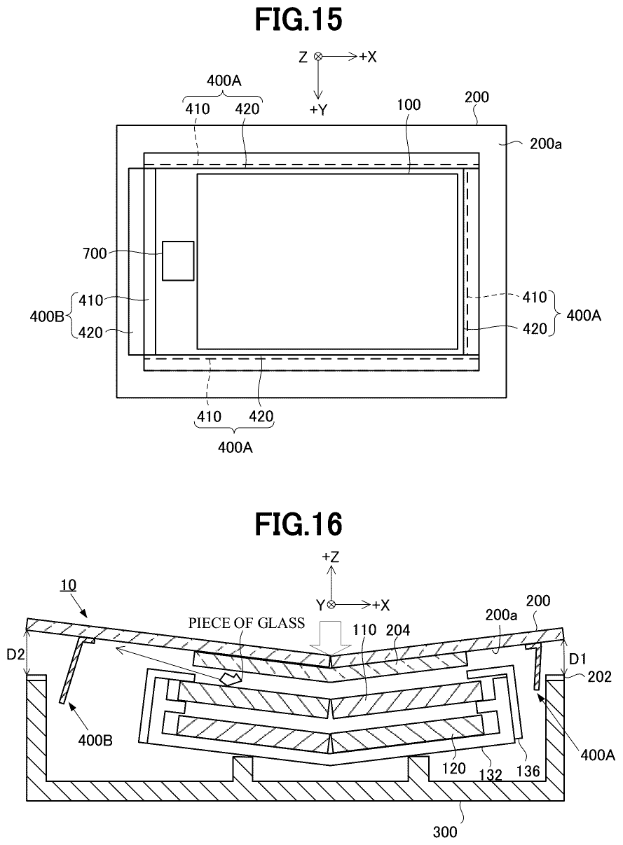

The first anti-scattering parts 400A and the first anti-scattering part 400B suppress scattering of pieces of glass, resin, metal, etc. caused due to damage of the display unit 100, similarly to the first anti-scattering part 400 of Embodiments 1 to 4. The first anti-scattering parts 400A and the first anti-scattering part 400B are formed of a synthetic resin, similarly to the first anti-scattering part 400 of Embodiment 1. As illustrated in FIGS. 14 and 15, each of the three first anti-scattering parts 400A and the single first anti-scattering part 400B is provided on the main surface 200a of the cover 200.

When viewed in plan, as illustrated in FIG. 15, the two first anti-scattering parts 400A extending along a long side (X direction) of the display unit 100 sandwich the display unit 100. One of the first anti-scattering parts 400A extending along a short side (Y direction) of the display unit 100 is disposed on the +X side of the display unit 100. The single first anti-scattering part 400B extending along the short side (Y direction) of the display unit 100 is disposed on the −X side of the imager 700 and the display unit 100. The three first anti-scattering parts 400A and the single first anti-scattering part 400B surround the display unit 100 and the imager 700.

The first anti-scattering parts 400A and the first anti-scattering part 400B each include the first fixing portion 410 and the first shielding portion 420, similarly to the first anti-scattering part 400 of Embodiments 1 to 4. The first fixing portion 410 is attached to the main surface 200a of the cover 200 via an adhesive member. As illustrated in FIG. 14, the first shielding portion 420 of the first anti-scattering part 400A extends from the first fixing portion 410 to between the side surface 136a of the display unit 100 and the inner surface 320a of the side plate 320 of the housing 300. The first shielding portion 420 of the first anti-scattering part 400A is inclined at an acute angle toward the side surface 136a side of the display unit 100 with respect to the rear direction of the display unit 100, similarly to the first shielding portion 420 of Embodiments 1 to 3. The first shielding portion 420 of the first anti-scattering part 400B extends from the first fixing portion 410 to between the side surface 136a of the display unit 100 and the inner surface 320a of the side plate 320 of the housing 300, and the first shielding portion 420 of the first anti-scattering part 400B and the side surface 136a of the display unit 100 sandwich the imager 700. The first shielding portion 420 of the first anti-scattering part 400B is inclined at an acute angle toward the inner surface 320a side of the housing 300 with respect to the rear surface of the display unit 100, similarly to the first shielding portion 420 of Embodiment 4.

In the present embodiment, a height H2 of the end portion 422 (end portion not connected to the fixing portion) of the first shielding portion 420 of the first anti-scattering part 400B from the cover 200 is different from a height H1 of the end portion 422 of the first shielding portion 420 of the first anti-scattering part 400A from the cover 200. Specifically, the height H2 of the end portion 422 of the first shielding portion 420 of the first anti-scattering part 400B from the cover 200 is greater than the height H1 of the end portion 422 of the first shielding portion 420 of the first anti-scattering part 400A from the cover 200. In other words, the height H2 of the end portion 422 of the first shielding portion 420 of the first anti-scattering part 400B from the cover 200 is higher than the height H1 of the end portion 422 of the first shielding portion 420 of the first anti-scattering part 400A from the cover 200. The height of the end portion 422 from the cover 200 is also represented by the position of the display unit 100 in the rear direction with respect to the cover 200 of the end portion 422.

In the present embodiment, the center line DZ bisecting the display unit 100 is shifted in the +X direction with respect to the center line CZ bisecting the cover 200, and thus, when the display device 10 is damaged due to an impact applied on the display unit 100 through the cover 200, the gap D2 between the cover 200 and the side plate 320 of the housing 300 on the −X side gets wider than the gap D1 between the cover 200 and the side plate 320 of the housing 300 on the +X side, as illustrated in FIG. 16. The height H2 of the end portion 422 of the first shielding portion 420 of the first anti-scattering part 400B disposed on the −X side of the display unit 100 and the imager 700 is greater than the height H1 of the end portion 422 of the first shielding portion 420 of the first anti-scattering part 400A. Thus, the first shielding portion 420 of the first anti-scattering part 400B can easily close the wide gap D2 and suppress scattering of pieces of glass, metal, etc. into the vehicle.

As above, the display device 10 of the present embodiment can suppress scattering of pieces of glass, metal, etc. due to damage into the vehicle and enhance the safety for users.

### Embodiment 6

In Embodiment 1, the display device 10 includes a single display unit 100. The display device 10 may include a plurality of display units 100. The display device 10 may include second anti-scattering parts 440 that extend between two juxtaposed display units 100.

The display device 10 of the present embodiment includes the two display units 100, the cover 200, the housing 300, four first anti-scattering parts 400, and two second anti-scattering parts 440. The configurations of the cover 200 of the present embodiment is the same as in Embodiment 1 and, as such, here, the display units 100, the housing 300, the first anti-scattering parts 400, and the second anti-scattering parts 440 are described.

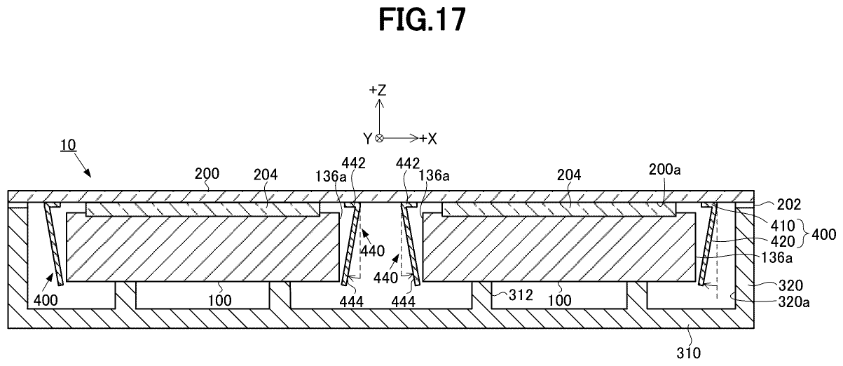

In the present embodiment, as illustrated in FIG. 17, the two display units 100 are juxtaposed in the X direction and accommodated in the housing 300. The space between the cover 200 and each of the display units 100 is filled with the light-transmitting adhesive 204. The other configurations of the display unit 100 of the present embodiment are the same as in Embodiment 1.

The housing 300 of the present embodiment accommodates the two display units 100. The other configurations of the housing 300 of the present embodiment are the same as in Embodiment 1.

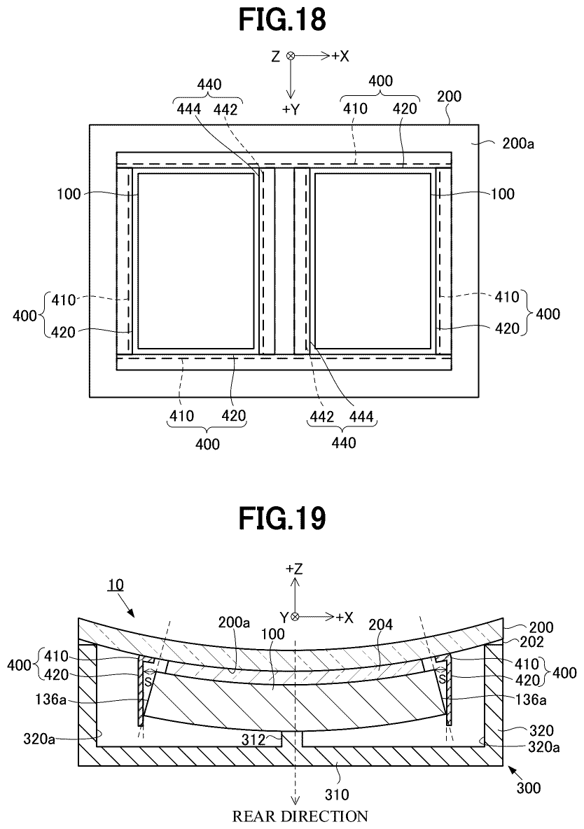

When viewed in plan, as illustrated in FIG. 18, the two first anti-scattering parts 400 of the present embodiment extend in the X direction, and sandwich the two display units 100. Also, the other two first anti-scattering parts 400 of the present embodiment extend in the Y direction, and sandwich the two display units 100. The four first anti-scattering part 400 of the present embodiment surround the two display units 100 in a frame-like manner. The other configurations of the first anti-scattering parts 400 of the present embodiment are the same as in Embodiment 1.

The second anti-scattering parts 440 suppress scattering of pieces of glass, resin, metal, etc. caused due to damage of the display unit 100, similarly to the first anti-scattering parts 400. The second anti-scattering parts 440 are disposed on the main surface 200a of the cover 200, similarly to the first anti-scattering parts 400. The second anti-scattering part 440 is disposed between the two juxtaposed display units 100 when viewed in plan. In the present embodiment, the two second anti-scattering parts 440 extending in the Y direction are arranged side by side in the X direction between the two juxtaposed display units 100.

The second anti-scattering part 440 is formed of a synthetic resin, metal, rubber, etc., similarly to the first anti-scattering part 400. The second anti-scattering part 440 includes a second fixing portion 442 and a second shielding portion 444. The second fixing portion 442 is attached to the main surface 200a of the cover 200 via an adhesive member.

The second shielding portions 444 extend between the two display units 100 from the second fixing portions 442, as illustrated in FIG. 17. The second shielding portion 444 of the second anti-scattering part 440 positioned on the −X side is inclined at an acute angle toward the side surface 136a of the display unit 100 positioned on the −X side with respect to the rear direction of the display unit 100 positioned on the −X side. The second shielding portion 444 of the second anti-scattering part 440 positioned on the +X side is inclined at an acute angle toward the side surface 136a side of the display unit 100 positioned on the +X side with respect to the rear direction of the display unit 100 positioned on the +X side.

In the present embodiment, the first anti-scattering part 400 can suppress pieces of glass, resin, metal, etc. into the vehicle through between the cover 200 and the display unit 100, similarly to Embodiment 1. When viewed in plan, the four first anti-scattering parts 400 surround the two display units 100 in a frame-like manner. Thus, even if an impact is applied between the two display units 100, scattering of pieces of glass, resin, metal, etc. into the vehicle can be suppressed.

When the display device 10 is damaged, the second shielding portion 444 of the second anti-scattering part 440 extends between the two display units 100, and thus, the second shielding portion 444 closes the gap between the cover 200 and the display unit 100. This can further suppress scattering of pieces of glass, resin, metal, etc. into the vehicle through between the cover 200 and the display unit 100.

In addition, the second shielding portion 444 is inclined at an acute angle toward the side surface 136a side of the display unit 100 with respect to the rear direction of the display unit 100, and thus the gap between the side surface 136a of the display unit 100 and the second shielding portion 444 can be narrowed. Even if the cover 200 deforms, the second shielding portion 444 is inclined at an acute angle toward the side surface 136a side of the display unit 100 with respect to the rear direction of the display unit 100, and thus, expansion of the gap between the side surface 136a of the display unit 100 and the second shielding portion 444 can be suppressed. This can suppress scattering of pieces of glass, resin, metal, etc. from between the second shielding portion 444 and the display unit 100.

As above, the display device 10 of the present embodiment can further suppress scattering of pieces of glass, metal, etc. due to damage into the vehicle and enhance the safety for users.

### Embodiment 7

In Embodiment 1, the display unit 100 and the cover 200 have a flat plate shape. The display unit 100 and the cover 200 may be curved.

The display device 10 of the present embodiment includes the display unit 100, the cover 200, the housing 300, and the four first anti-scattering parts 400, similarly to the display device 10 of Embodiment 1. The configurations of the housing 300 of the present embodiment is the same as in Embodiment 1 and, as such, here, the display unit 100, the cover 200, and the first anti-scattering parts 400 of the present embodiment are described.

The display unit 100 and the cover 200 of the present embodiment are curved concavely in the +Z direction (passenger side), as illustrated in FIG. 19. The other configurations of the display unit 100 and the cover 200 of the present embodiment are the same as in Embodiment 1.

The first anti-scattering part 400 of the present embodiment suppresses scattering of pieces of glass, resin, metal, etc. caused due to damage of the display unit 100, similarly to the first anti-scattering part 400 of Embodiment 1. The first anti-scattering part 400 of the present embodiment includes the first fixing portion 410 and the first shielding portion 420, similarly to the first anti-scattering part 400 of Embodiment 1. The first fixing portion 410 of the present embodiment is attached to the main surface 200a of the cover 200 via an adhesive member.

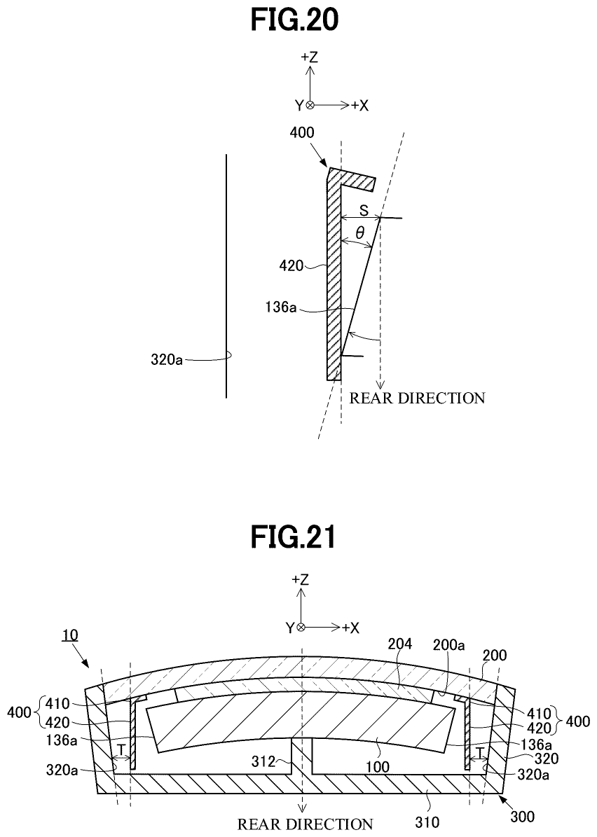

The first shielding portion 420 of the present embodiment extends from the first fixing portion 410 to between the side surface 136a of the display unit 100 and the inner surface 320a of the side plate 320 of the housing 300, similarly to the first shielding portion 420 of Embodiment 1. In addition, when viewed in cross-section, the first shielding portion 420 of the present embodiment is inclined with respect to the side surface 136a of the display unit 100 in a direction where the spacing S between the first shielding portion 420 and the side surface 136a of the display unit 100 gets narrowed toward the rear direction of the display unit 100, as illustrated in FIGS. 19 and 20.

In the present embodiment, the first shielding portion 420 extends from the first fixing portion 410 to between the side surface 136a of the display unit 100 and the inner surface 320a of the side plate 320 of the housing 300, and thus, the first shielding portion 420 can close the gap between the cover 200 and the display unit 100 and suppress scattering of pieces of glass, resin, metal, etc. into the vehicle. Also, the first shielding portion 420 is inclined in a direction where the spacing S between the first shielding portion 420 and the side surface 136a of the display unit 100 is narrowed toward the rear direction of the display unit 100, and thus, the gap between the side surface 136a of the display unit 100 and the first shielding portion 420 can be narrowed and scattering of pieces of glass, resin, metal, etc. into the vehicle can be further suppressed.

In the present embodiment, the side surface 136a of the display unit 100 is inclined toward the inner surface 320a side of the housing 300 with respect to the rear direction of the display unit 100, but the inclining direction of the side surface 136a of the display unit 100 with respect to the rear direction of the display unit 100 may be determined as desired. A configuration is possible in which the side surface 136a of the display unit 100 is not inclined with respect to the rear direction of the display unit 100. In the present embodiment, the first shielding portion 420 is in contact with the side surface 136a of the display unit 100. An angle θ between the first shielding portion 420 and the side surface 136a of the display unit 100 is an acute angle open to the passenger side (+Z direction), as illustrated in FIG. 20.

### Embodiment 8

In Embodiment 7, the cover 200 of the display unit 100 is curved concavely in the +Z direction (passenger side). The display unit 100 and cover 200 may be curved convexly in the +Z direction (passenger side).

The display device 10 of the present embodiment includes the display unit 100, the cover 200, the housing 300, and the four first anti-scattering parts 400, similarly to the display device 10 of Embodiment 1.

The display unit 100 and the cover 200 of the present embodiment are curved convexly in the +Z direction (passenger side), as illustrated in FIG. 21. The cover 200 of the present embodiment is attached to the inner surface 320a of the housing 300 by a non-illustrated adhesive member. The other configurations of the display unit 100 and the cover 200 of the present embodiment are the same as in Embodiment 1.

The housing 300 of the present embodiment accommodates the display unit 100. The housing 300 of the present embodiment has a box-like shape with a wider opening side than the bottom plate 310 as viewed in cross-section. In the housing 300 of the present embodiment, the side plate 320 opens toward the outside of the housing 300 and the side plate 320 (inner surface 320a) is inclined toward the outside of the housing 300 with respect to the rear direction of the display unit 100.

The first anti-scattering part 400 of the present embodiment suppresses scattering of pieces of glass, resin, metal, etc. caused due to damage of the display unit 100, similarly to the first anti-scattering part 400 of Embodiment 1. The first anti-scattering part 400 of the present embodiment includes the first fixing portion 410 and the first shielding portion 420. The first fixing portion 410 of the present embodiment is attached to the main surface 200a of the cover 200 via an adhesive member.

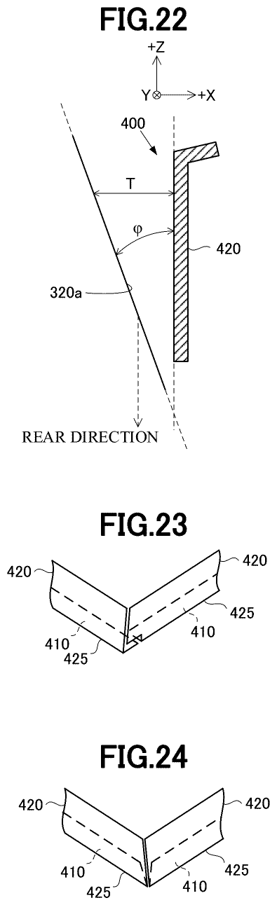

The first shielding portion 420 of the present embodiment extends from the first fixing portion 410 to between the side surface 136a of the display unit 100 and the inner surface 320a of the side plate 320 of the housing 300, similarly to the first shielding portion 420 of Embodiment 1. When viewed in cross-section, the first shielding portion 420 of the present embodiment is inclined with respect to the inner surface 320a of the housing 300 in a direction where the spacing T between the first shielding portion 420 and the inner surface 320a get narrowed toward the rear direction of the display unit 100, as illustrated in FIGS. 21 and 22.

In the present embodiment, the first shielding portion 420 extends from the first fixing portion 410 to between the side surface 136a of the display unit 100 and the inner surface 320a of the side plate 320 of the housing 300, and thus, the first shielding portion 420 can close the gap between the cover 200 and the display unit 100 and suppress scattering of pieces of glass, resin, metal, etc. into the vehicle. Also, the first shielding portion 420 is inclined in a direction where the spacing T between the first shielding portion 420 and the inner surface 320a is narrowed toward the rear direction of the display unit 100, and thus, the gap between the inner surface 320a and the first shielding portion 420 can be narrowed and scattering of pieces of glass, resin, metal, etc. can be further suppressed.

In the present embodiment, the side plate 320 (inner surface 320a) of the housing 300 is inclined toward the outside of the housing 300 with respect to the rear direction of the display unit 100, but the inclining direction of the side plate 320 of the housing 300 with respect to the rear direction may be determined as desired. A configuration is possible in which the side plate 320 of the housing 300 is not inclined with respect to the rear direction of the display unit 100. An angle φ between the first shielding portion 420 and the inner surface 320a is an acute angle open to the passenger side (+Z direction), as illustrated in FIG. 22.

### Modified Examples

Although the embodiments have been described above, various modifications can be made without departing from the sprit and scope of the present disclosure.

For example, a configuration is possible in which the display unit 100 includes an organic electro-luminescence (EL) display panel instead of the liquid crystal display panel 110 and the back light 120. A configuration is possible in which the display unit 100 does not include the unit housing 130.

The display device 10 may include a touch panel between the cover 200 and the display unit 100. The touch panel is adhered to each of the cover 200 and the liquid crystal display panel 110 of the display unit 100, for example, by a light-transmitting adhesive.

In the embodiments, the display device 10 includes a plurality of first anti-scattering parts 400, 400A, 400B, but it is sufficient that the display device 10 includes at least one first anti-scattering part 400, 400A, 400B.

FIGS. 23 and 24 are perspective views illustrating end portions of the first anti-scattering part 400. As illustrated in FIGS. 23 and 24, the end portion of the first fixing portion 410 and the first shielding portion 420 of the first anti-scattering part 400 may be notched, and the ends of the first shielding portions 420 of the adjacent first anti-scattering parts 400 may abut each other. This can narrow the gap between adjacent first anti-scattering parts 400 and suppress scattering of pieces of glass, resin, metal, etc.

In Embodiment 1, the first anti-scattering part 400 has an L-shape and is disposed with the junction 425 (L-shaped bend) facing the outer periphery (that is, the side plate 320 side of the housing 300) of the cover 200. The first anti-scattering part 400 having an L-shape may be disposed with the junction 425 facing the side surface 136a side of the display unit 100 (For example, in FIG. 10).

In Embodiments 1 and 2, the end portion 422 of the first shielding portion 420 is positioned near the bottom surface 132a (bottom surface 132a of the chassis 132) of the display unit 100. The position (height of the end portion 422 of the first shielding portion 420 from the cover 200) of the end portion 422 of the first shielding portion 420 may be determined as desired. For example, the end portion 422 of the first shielding portion 420 may protrude in the rear direction from a plane including the bottom surface 132a of the display unit 100. The end portion 422 of the first shielding portion 420 is positioned between the bottom surface 132a of the display unit 100 and the bottom plate 310 of the housing 300.

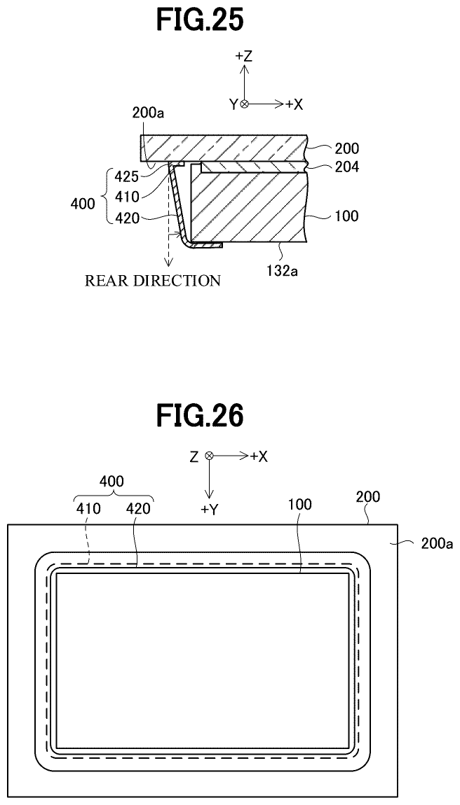

The first shielding portion 420 of the first anti-scattering part 400 may extend to the bottom surface 132a of the display unit 100, as illustrated in FIG. 25. This can suppress widening of the gap between the first anti-scattering part 400 and the display unit 100 even if the cover 200 is greatly deformed. In particular, when the display unit 100 is formed of a thin display panel, such as an organic EL display panel, scattering of pieces of glass, resin, metal, etc. into the vehicle can be further suppressed by extending the first shielding portion 420 to the bottom surface 132a of the display unit 100.

When viewed in plan, the first anti-scattering part 400 having a single-frame shape may surround one display unit 100 in a frame-like manner, as illustrated in FIG. 26. This can suppress scattering of pieces of glass, metal, etc.

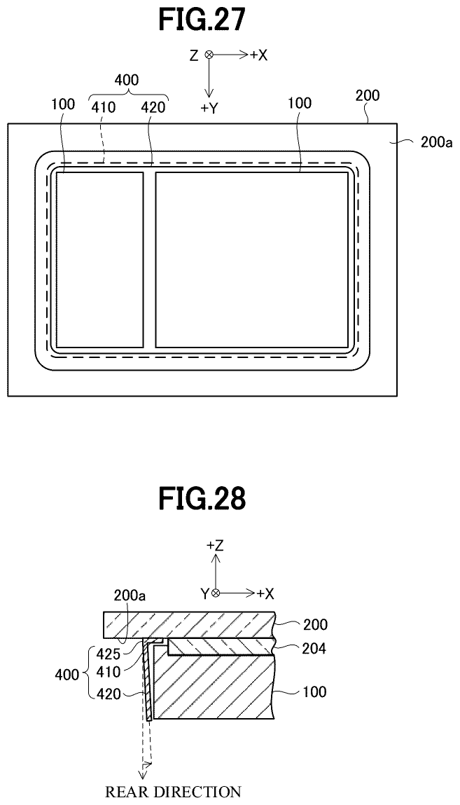

Furthermore, as illustrated in FIG. 27, a first anti-scattering part 400 having a single frame shape may surround a plurality of display units 100 in a frame-like manner. This can suppress scattering of pieces of glass, metal, etc.

The first shielding portion 420 of Embodiments 1 and 6 may be in contact with the display unit 100 (side surface 136a), similarly to the first shielding portion 420 of Embodiment 2. The first shielding portion 420 of Embodiment 4 may be in contact with the inner surface 320a of the housing 300.

The first anti-scattering part 400 of Embodiment 4 may be formed of metal, rubber, etc. having elasticity (spring property), similarly to the first anti-scattering part 400 of Embodiment 2. In this case, the first shielding portion 420 of the first anti-scattering part 400 may be in contact with the inner surface 320a of the housing 300 and press the inner surface 320a.

In Embodiments 1 to 6, the first shielding portion 420 of the first anti-scattering part 400 is inclined at an acute angle with respect to the rear direction of the display unit 100. The cover 200 of Embodiments 1 to 6 has a flat plate shape, and thus the first shielding portion 420 of the first anti-scattering part 400 can also be expressed as being inclined at an acute angle with respect to the normal line on the display unit 100 side of the main surface 200a of the cover 200.

The first fixing portion 410 of the first anti-scattering part 400 may be positioned between the cover 200 and the display unit 100, as illustrated in FIG. 28. This can narrow the spacing between the display unit 100 and the side plate 320 of the housing 300.

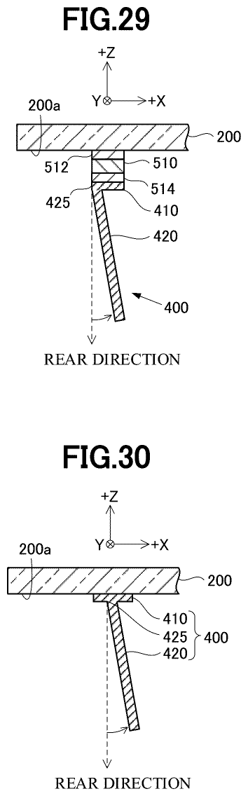

The first fixing portion 410 of the first anti-scattering part 400 may be attached to the main surface 200a of the cover 200 via an elastic body 510, as illustrated in FIG. 29. When the display device 10 is damaged, this can suppress falling off of the first anti-scattering part 400 from the cover 200. The elastic body 510 is formed of rubber, a sponge-like material, etc. In the example illustrated in FIG. 29, the elastic body 510 is adhered to the main surface 200a of the cover 200 by the adhesive member 512, and the first fixing portion 410 is adhered to the elastic body 510 by the adhesive member 514. The second fixing portion 442 of the second anti-scattering part 440 may also be attached to the main surface 200a of the cover 200 via an elastic body 510, similarly to the first fixing portion 410 of the first anti-scattering part 400.

Attachment of the first fixing portion 410 of the first anti-scattering part 400 and the second fixing portion 442 of the second anti-scattering part 440 is not limited to adhesion. For example, the first fixing portion 410 of the first anti-scattering part 400 may be attached to the main surface 200a of the cover 200 by screwing.

In the present embodiment, the first anti-scattering part 400 has an L-shape with the first shielding portion 420 inclined at an acute angle with respect to the rear direction of the display unit 100 when viewed in cross-section. As illustrated in FIG. 30, the first anti-scattering part 400 may have a T-shape with the first shielding portion 420 inclined at an acute angle with respect to the rear direction of the display unit 100 when viewed in cross-section. This can make the first anti-scattering part 400 more difficult to fall off from the cover 200. The second anti-scattering part 440 may have a T-shape, similarly to the first anti-scattering part 400.

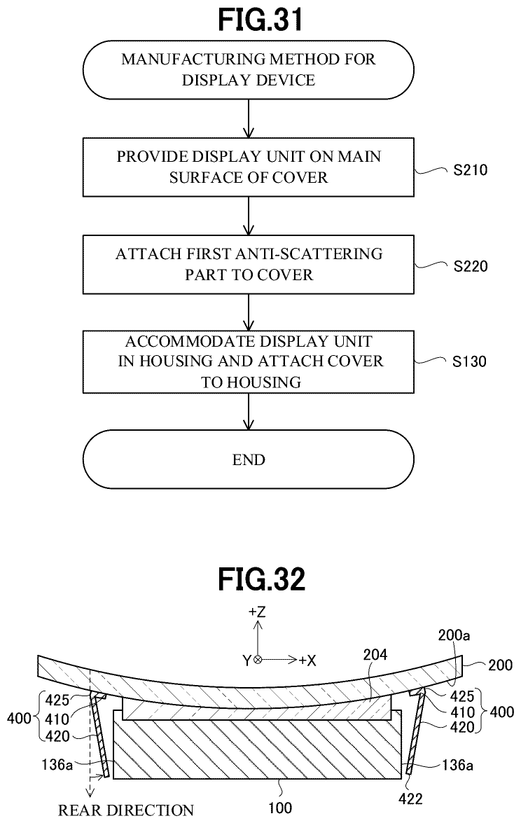

In the manufacturing method for the display device 10 in Embodiment 2, the first anti-scattering part 400 is attached to the main surface 200a of the cover 200 before the display unit 100 is provided on the main surface 200a of the cover 200. As illustrated in FIG. 31, the manufacturing method for the display device 10 in Embodiment 2 may include a step of providing the display unit 100 on the main surface 200a of the cover 200 (step S210), a step of attaching the first anti-scattering part 400 to the cover 200 (step S220), and a step of accommodating the display unit 100 in the housing 300 and attaching the cover 200 to the housing 300 (step S130). In step S210, the display unit 100 with the adhesive 204 applied on the display surface 110a is provided on the main surface 200a of the cover 200. Then, the adhesive 204 is cured to adhere the display unit 100 to the cover 200. In step S220, the first anti-scattering part 400 is attached to the main surface 200a of the cover 200 by the adhesive member while the first shielding portion 420 of the first anti-scattering part 400 is pressed on the side surface 136a of the display unit 100. Step S130 is the same as in Embodiment 2. As above, the display device 10 of Embodiment 2 can be manufactured.

In the embodiments, the cover 200 is attached to the side plate 320 of the housing 300. A configuration is possible in which the cover 200 is not attached to the housing 300. The cover 200 may be attached, for example, to the instrument panel 600.

In Embodiments 1 to 6, the cover 200 has a flat plate shape. The cover 200 may be curved concavely in the +Z direction (passenger side), as illustrated in FIG. 32. Also, the cover 200 may be curved convexly in the +Z direction (passenger side).

The second anti-scattering part 440 may be in contact with a side surface 136a of the display unit 100, similarly to the first anti-scattering part 400. The second anti-scattering part 440 may press the side surface 136a of the display unit 100.

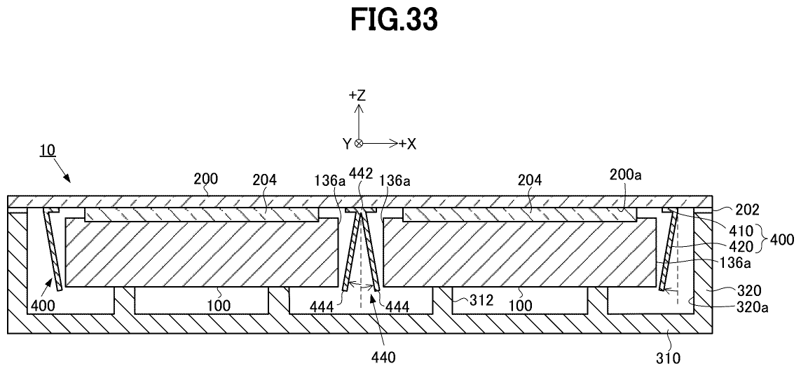

In Embodiment 6, the display device 10 includes the two second anti-scattering parts 440. As illustrated in FIG. 33, the display device 10 may include a single second anti-scattering part 440. In the example illustrated in FIG. 33, the second anti-scattering part 440 includes a single second fixing portion 442 and two second shielding portions 444. The two second shielding portions 444 are formed in a V-shape. The second shielding portion 444 positioned on the −X side is inclined at an acute angle toward the side surface 136a side of the display unit 100 positioned on the −X side with respect to the rear direction of the display unit 100 positioned on the −X side. Also, the second shielding portion 444 positioned on the +X side is inclined at an acute angle toward the side surface 136a side of the display unit 100 positioned on the +X side with respect to the rear direction of the display unit 100 positioned on the +X side. In the present modified example, the spacing between the two display units 100 can be narrowed.

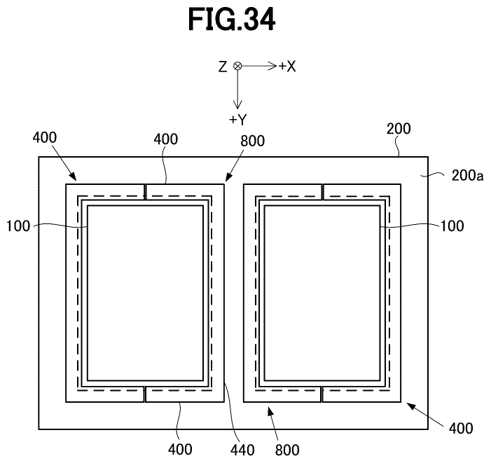

The first anti-scattering part 400 and the second anti-second anti-scattering part 440 are formed integrally. The first anti-scattering part 400 and the second anti-scattering part 440 that are formed integrally may surround the display unit 100 when viewed in plan. For example, as illustrated in FIG. 34, an anti-scattering part 800 in which the first anti-scattering part 400 is integrated with the second anti-scattering part 440 may be formed in a U-shape and surround the one display unit 100. In FIG. 34, the first anti-scattering part 400 and the anti-scattering part 800, formed in a U-shape, surround the one display unit 100 over the entire periphery of the display unit 100.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A display device comprising:
at least one display unit;
a cover disposed on a display surface side of the at least one display unit,
a housing that accommodates the at least one display unit; and
a first anti-scattering part disposed on the cover and extending between the display unit and an inner surface of the housing, wherein
the first anti-scattering part is inclined at an acute angle with respect to a rear direction of the display unit.

2. The display device according to claim 1, wherein
the first anti-scattering part includes a first fixing portion attached to the cover and a first shielding portion extending from the first fixing portion between the display unit and the inner surface of the housing and inclined at an acute angle with respect to the rear direction of the display unit.

3. The display device according to claim 2, wherein
the first shielding portion is in contact with a side surface of the display unit or the inner surface of the housing.

4. The display device according to claim 2, wherein
the first shielding portion is pressed on a side surface of the display unit or the inner surface of the housing.

5. The display device according to claim 2, wherein
the first shielding portion extends to a bottom surface of the display unit.

6. The display device according to claim 2, wherein
the first fixing portion is attached to the cover via an elastic body.

7. The display device according to claim 2, wherein
the first fixing portion is positioned between the cover and the display unit.

8. The display device according to claim 2, wherein
the first fixing portion is positioned between the cover and a side plate of the housing and is adhered to the cover and the side plate of the housing, and
adhesion to adhere the first fixing portion to the cover is greater than adhesion to adhere the first fixing portion to the side plate of the housing.

9. The display device according to claim 1, wherein
the first anti-scattering part has a T-shape when viewed in cross-section.

10. The display device according to claim 1, wherein
the first anti-scattering part surrounds the at least one display unit in a frame-like manner.

11. The display device according to claim 2, wherein
the first anti-scattering part includes a plurality of the first anti-scattering parts having different heights of end portions of the plurality of first shielding portions from the cover.

12. The display device according to claim 1, further comprising
a plurality of the display units that are juxtaposed; and
a second anti-scattering part disposed on the cover and extending between one display unit of the plurality of juxtaposed display units and the other display unit of the plurality of juxtaposed display units, wherein
the second anti-scattering part is inclined at an acute angle with respect to the rear direction of the one display unit.

13. The display device according to claim 12, wherein
the second anti-scattering part includes a second fixing portion attached to the cover and a second shielding portion extending from the second fixing portion between the one display unit and the other display unit and inclined at an acute angle with respect to the rear direction of the one display unit.

14. The display device according to claim 12, wherein
the first anti-scattering part and the second anti-scattering part are formed integrally and surround the one display unit.

15. The display device according to claim 13, wherein
the second shielding portion is in contact with a side surface of the one display unit.

16. The display device according to claim 13, wherein
the second shielding portion is pressed on a side surface the one display unit.

17. A manufacturing method for a display device, the manufacturing method comprising:
a first step of attaching an anti-scattering part to a main surface of a cover;
a second step of providing a display unit on the main surface of the cover to which the anti-scattering part is attached, wherein
the anti-scattering part extends in a rear direction of the display unit and is inclined toward a display unit side with respect to the rear direction of the display unit, and
in the second step, the display unit is provided on the main surface of the cover, with the anti-scattering part pressed on a side opposite an area where the display unit is provided.

18. A manufacturing method for a display device, the manufacturing method comprising:
a first step of providing a display unit on a main surface of a cover; and
a second step of attaching, to the cover on which the display unit is provided, an anti-scattering part extending in a rear direction of the display unit and inclined toward a display unit side with respect to the rear direction of the display unit.
